(19) United States
(12) Patent Application Publication
(10) Pub. No.: US 2025/0156427 A1
(43) Pub. Date: May 15, 2025

(54) GRAPH NEURAL NETWORK SYSTEM FOR LARGE-SCALE ITEM RANKING

(71) Applicant: Walmart Apollo, LLC, Bentonville, AR (US)

(72) Inventors: Seyed Danial Mohseni Taheri, Santa Clara, CA (US); Hongwei Shang, Sunnyvale, CA (US); Changsung Kang, San Jose, CA (US)

(21) Appl. No.: 18/820,794

(22) Filed: Aug. 30, 2024

Related U.S. Application Data
(60) Provisional application No. 63/599,010, filed on Nov. 15, 2023.

(51) Int. Cl. G06F 16/2457; G06F 16/2455

(52) U.S. Cl. CPC G06F 16/24578; G06F 16/2455

(57) ABSTRACT

This application is directed to systems and methods for ranking items in response to a query. In some embodiments, a disclosed method includes identifying a plurality of items to be provided in response to a first query and determining a plurality of messages. A first item of the plurality of items was previously engaged by former users in response to a plurality of second queries, and corresponds to a first message determined based on the second queries. The method further includes determining a query feature vector of the first query based on the messages including the first message of the first item, ranking the items associated with the first query into an ordered item list based on the query feature vector, and in response to receiving the first query from a next user, presenting information of the items based on the ordered item list on an electronic device.

### RELATED APPLICATION

This application claims priority to U.S. Provisional Patent Application No. 63/599,010, filed Nov. 15, 2023, titled “Graph Neural Network System for Large-Scale Item Ranking,’ which is incorporated by reference in its entirety.

### TECHNICAL FIELD

This application relates generally to graph neural networks and, more particularly, to systems and methods for generating search responses to a query within a cloud-based service platform.

### BACKGROUND

Cloud-based service platforms provide information of data items in response to a user query. The data items are oftentimes ranked to enhance visibility and accessibility of products associated with the data items to potential customers, thereby improving user engagement (e.g., orders, clicks for review). Logs are recorded to track user engagement and become valuable resources that provide information about query-item pairs for tasks in further information retrieval. User engagement information tracked in the logs is leveraged to build engagement-based features associated with user queries and related data items. Although the user engagement information has been widely used to derive a relevance between a query and a data item, it is noisy and covers a limited number of data items, which inevitably compromises an accuracy of query-item relevance determination.

### SUMMARY

In various embodiments, a system including a non-transitory memory configured to store instructions thereon and at least one processor is disclosed. The at least one processor is configured to read the instructions to identify a plurality of items to be provided in response to a first query. The plurality of items includes a first item that was previously engaged by at least one prior user in response to a plurality of second queries. The at least one processor is further configured to read the instructions to determine a plurality of messages for the plurality of items associated with the first query including determining a first message of the first item based on the plurality of second queries, determine a query feature vector of the first query based on the plurality of messages including the first message of the first item; rank the plurality of items associated with the first query into an ordered item list based on the query feature vector, and, in response to receiving the first query from a next user, present information of the plurality of items based on the ordered item list on a screen of an electronic device associated with the next user.

In various embodiments, a computer-implemented method is disclosed. The computer-implemented method includes a step of identifying a plurality of items to be provided in response to a first query. The plurality of items includes a first item that was previously engaged by at least one prior user in response to a plurality of second queries. The computer-implemented method further includes steps of determining a plurality of messages for the plurality of items associated with the first query including determining a first message of the first item based on the plurality of second queries, determining a query feature vector of the first query based on the plurality of messages including the first message of the first item, ranking the plurality of items associated with the first query into an ordered item list based on the query feature vector, and, in response to receiving the first query from a next user, presenting information of the plurality of items based on the ordered item list on a screen of an electronic device associated with the next user.

In various embodiments, a non-transitory computer readable medium having instructions stored thereon is disclosed. The instructions, when executed by at least one processor, cause at least one device to perform operations including identifying a plurality of items to be provided in response to a first query. The plurality of items includes a first item that was previously engaged by at least one prior user in response to a plurality of second queries. The at least one device further performs operations including determining a plurality of messages for the plurality of items associated with the first query including determining a first message of the first item based on the plurality of second queries, determining a query feature vector of the first query based on the plurality of messages including the first message of the first item, ranking the plurality of items associated with the first query into an ordered item list based on the query feature vector, and, in response to receiving the first query from a next user, presenting information of the plurality of items based on the ordered item list on a screen of an electronic device associated with the next user.

### BRIEF DESCRIPTION OF THE DRAWINGS

The features and advantages of the present disclosure will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of tenants, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8A is a flow diagram of an example process of determining relevance levels between queries and items, in accordance with some embodiments;

FIGS. 8B and 8C are schematic diagrams of two example engagement graphs, in accordance with some embodiments;

FIG. 9A is a flow diagram of an example process of determining a relevance level between a query and an item, in accordance with some embodiments;

FIG. 9B is a diagram showing example formulas for determining the relevance level 810 between a query and an item, in accordance with some embodiments;

FIG. 10A is a flow diagram of an example process of determining a relevance level between an isolated query and an item, in accordance with some embodiments;

FIG. 10B is a diagram showing example formulas for determining the relevance level between an isolated query shown in FIG. 10A and an item, in accordance with some embodiments;

FIG. 10C is a diagram showing example program codes for applying neighbor sampling to compute feature vectors at every layer of an engagement graph, in accordance with some embodiments;

FIG. 11A is a structural diagram of an example engagement graph of a first query, in accordance with some embodiments;

FIG. 11B is a structural diagram of an input graph consolidated from the engagement graph shown in FIG. 11A, in accordance with some embodiments;

FIG. 12 is a block diagram of an example model training module for training a graph-based relevance model, in accordance with some embodiments;

FIG. 13 is a flow diagram of an example process for inferring items and queries and updating query-item embeddings in an engagement graph, in accordance with some embodiments; and

FIG. 14 is a flowchart illustrating an example method for ranking items to be presented in response to a query, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Various embodiments described herein are directed to systems and methods for establishing a graph of multi-level user engagement between queries and items and applying a graph-based relevance model to combine features of selected neighboring nodes on each query-item level. Example user engagements include user clicks, add-to-cart, and orders of an item in response to a query. The graph-based relevance model leverages features of the neighboring nodes of a query node or an item node on a corresponding query-item level to construct messages of the neighboring nodes, which may be further combined to represent the query or item node. In some embodiments, the neighboring nodes are selected based on edge weights that are derived from the user engagement information and associated features and messages may be determined based on semantic weights independently of the user engagement information. User engagement information of queries and items may be used to characterize the queries and items jointly with query and item features (e.g., query description, item title, and item attributes). By these means, high-quality embeddings (also called feature vectors) are created to associate items and queries and determine their similarity or relevance score based on both of their associated features and the user engagement information.

In some embodiments, embeddings (e.g., feature vectors) of queries and items are established based on their own features and their neighboring nodes' features. Neighboring nodes of each query or item may be identified according to an engagement graph that indicates historical users' engagement. In some situations, a computing device considers items and queries with engagement and updates their embeddings, e.g., regularly, upon a request, according to a schedule, or in accordance with detection of a change in their neighboring nodes or features. In some embodiments, the computing device constructs a bipartite graph that connects queries to items based on prior user engagement data (e.g., stored in a log) and eliminates noisy engagement based on edge weights (also called engagement weights). The graph has one or more query-item levels, and each query-item level couples a central query or item node with one or more neighboring item or query nodes, respectively. Edge weights are defined in the graph based on a number of clicks, add-to-carts, orders, and user impressions to differentiate a strong query-item connection from a weak query-item connection. The computing device further ranks neighboring nodes based on their edge weights and chooses neighboring nodes with the largest edge weights. Semantic weights may be determined between a central node and the sampled neighboring nodes and a weighted average of the neighboring nodes' features is further determined in a node embedding space.

In some embodiments, the query-item embeddings are generated for queries and items having historical engagement. Alternatively, in some embodiments, the query-item embeddings are generated for queries and isolated items having no engagement. A pseudo query may be defined for each isolated item having no engagement and passed through one or more convolution layers in the graph-based relevance model. For example, a pseudo query may include a title of an item. A similarity or relevance level may be determined between a query and the isolated item having no neighboring node and used to rank the isolated item among a set of neighboring nodes (e.g., a set of neighboring items) of the query.

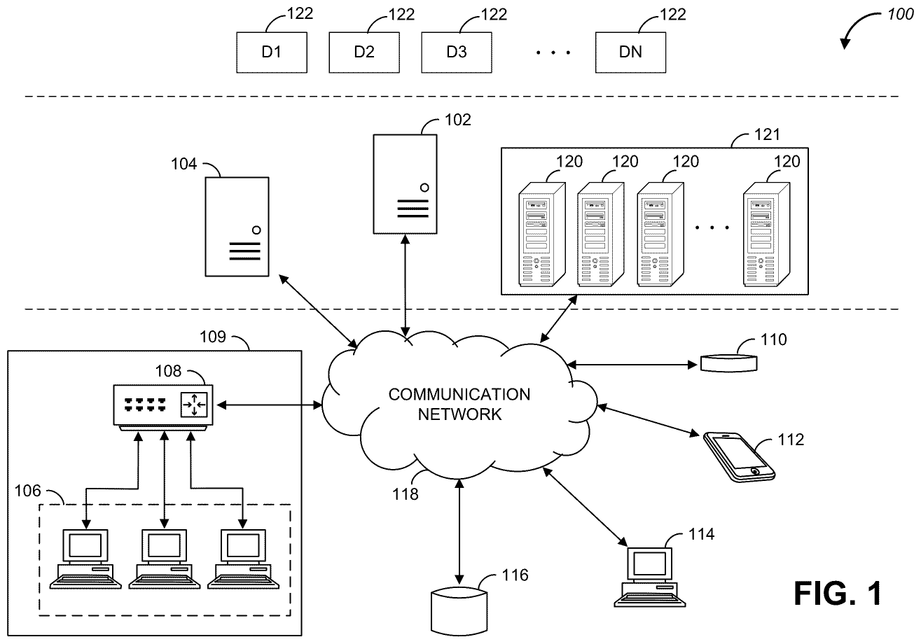

FIG. 1 is a network environment configured to provide a user application (e.g., a network interface application) to a plurality of tenants, in accordance with some embodiments. The network environment 100 includes a plurality of devices or systems configured to communicate over one or more network channels, illustrated as a network cloud 118. For example, in various embodiments, the network environment 100 can include, but not limited to, an item ranking computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The item ranking computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item ranking computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the item ranking computing device 102.

In some examples, each of the user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the item ranking computing device 102, the processing devices 120, and/or the web server 104 are operated by a network environment provider, and the multiple user computing devices 110, 112, 114 are operated by users of the network environment. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 can communicate with the item ranking computing device 102 over the communication network 118. The workstation(s) 106 may send data to, and receive data from, the item ranking computing device 102.

Although FIG. 1 illustrates three user computing devices 110, 112, 114, the network environment 100 can include any number of user computing devices 110, 112, 114. Similarly, the network environment 100 can include any number of the item ranking computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the item ranking computing device 102 over the communication network 118.

In some examples, the item ranking computing device 102 may execute one or more models, such as a trained graph-based relevance model, deep learning model, statistical model, etc., to determine a relevance score between a query and each of a plurality of items and/or rank a plurality of items associated with a query into an ordered item list. The item ranking computing device 102 may transmit the ordered item list to the web server 104 over the communication network 118, and the web server 104 may present information of the plurality of items based on the ordered item list on a screen of an electronic device associated with a next user who makes the query.

The item ranking computing device 102 is further operable to communicate with the database 116 over the communication network 118. For example, the item ranking computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item ranking computing device 102, in some examples, the database 116 can be a local storage device, such as a hard drive, a non-volatile memory, or a USB stick. The item ranking computing device 102 may store purchase data received from the web server 104 in the database 116. The item ranking computing device 102 may also receive from the web server 104 user session data identifying events associated with browsing sessions, and may store the user session data in the database 116.

In some examples, the item ranking computing device 102 generates training data for a plurality of models (e.g., machine learning models, deep learning models, statistical models, algorithms, etc.) based on image data, historical user session data, etc. The item ranking computing device 102 may train the models based on their corresponding training data and may store the models in a database, such as in the database 116 (e.g., a cloud storage).

The models, when executed by the item ranking computing device 102, allow the item ranking computing device 102 to determine item rankings of items to be displayed to a customer. For example, the item ranking computing device 102 may obtain the models from the database 116. The item ranking computing device 102 may then execute the models to determine a relevance score between a query and each of a plurality of items and/or rank a plurality of items associated with a query into an ordered item list.

In some examples, the item ranking computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, item ranking computing device 102 may generate ranked item recommendations for items to be displayed on the website to a user.

In some embodiments, the network environment 100 is configured to provide a user application (e.g., a network interface application) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 is authenticated and authorized to access the user application. For example, login pages are displayed on the workstation(s) 106 and the multiple customer computing devices 110, 112 and 114, allowing the plurality of users 122 to provide their credentials (e.g., user names, passwords). Upon authentication, requests associated with the plurality of users 122 (e.g., search requests, purchase requests, account review requests) are received from the workstation(s) 106 and customer computing devices 110, 112 and 114.

The network environment 100 is implemented to enable secure concurrent access experience by multiple users 122 of the user application. User queries of the plurality of users 122 are managed in a centralized manner by the item ranking computing device 102 and/or the cloud-based engine 121. In some embodiments, the item ranking computing device 102 and/or the cloud-based engine 121 identifies a plurality of items to be provided in response to a first query, and the plurality of items includes a first item that was previously engaged by former users in response to a plurality of second queries. A plurality of messages are determined for the plurality of items in association with the first query. The plurality of messages includes a first message of the first item determined based on the plurality of second queries. The item ranking computing device 102 and/or the cloud-based engine 121 determines a query feature vector of the first query based on the plurality of messages including the first message of the first item, ranks the plurality of items associated with the first query into an ordered item list based on the query feature vector, and, in response to receiving the first query from a next user, presents information of the plurality of items based on the ordered item list on a screen of an electronic device associated with the next user.

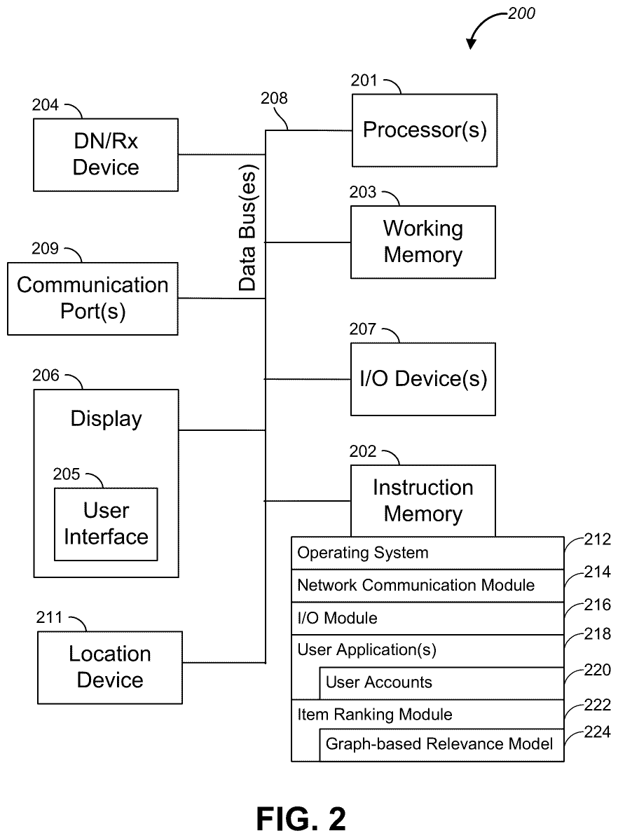

FIG. 2 is a block diagram of a computing device 200, in accordance with some embodiments of the present teaching. In some embodiments, each of the item ranking computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 202 can store instructions that can be accessed (e.g., read) and executed by the processors 201. For example, the instruction memory 202 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 202, embodying the function or operation. For example, the processors 201 can be configured to execute code stored in the instruction memory 202 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 202. The processors 201 can also use the working memory 202 to store dynamic data created during the operation of the item ranking computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 202. In some examples, the communication port(s) 209 allow for the transfer (e.g., uploading or downloading) of data, such as model training data.

The display 206 can be any suitable display, and may display the user interface 205. The user interfaces 205 can enable user interaction with the item ranking computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the item ranking computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the item ranking computing device 102 may determine a local geographical area (e.g., town, city, state, etc.) of its position.

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where an example of the user application 218 is a login application having a plurality of user accounts 220 associated with a plurality of users 122; and
Item ranking module 222 that is executed to determine a relevance level of a query and an item and rank a plurality of items associated with the query into an ordered item list using a graph-based relevance model 224.

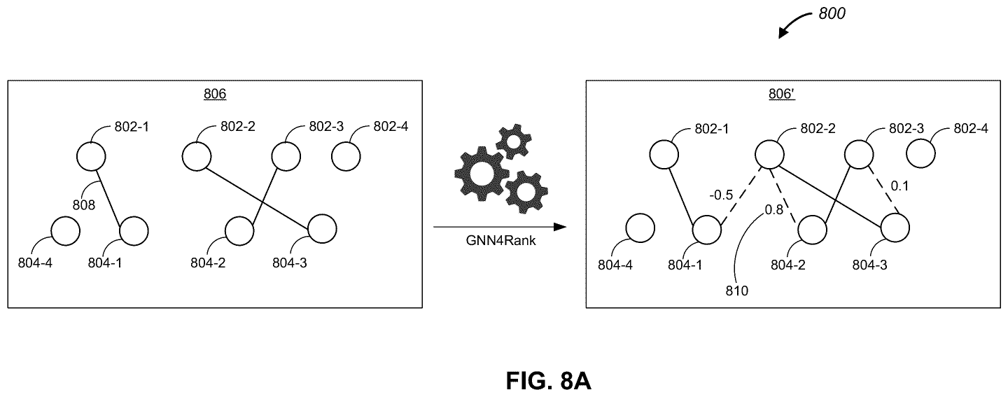

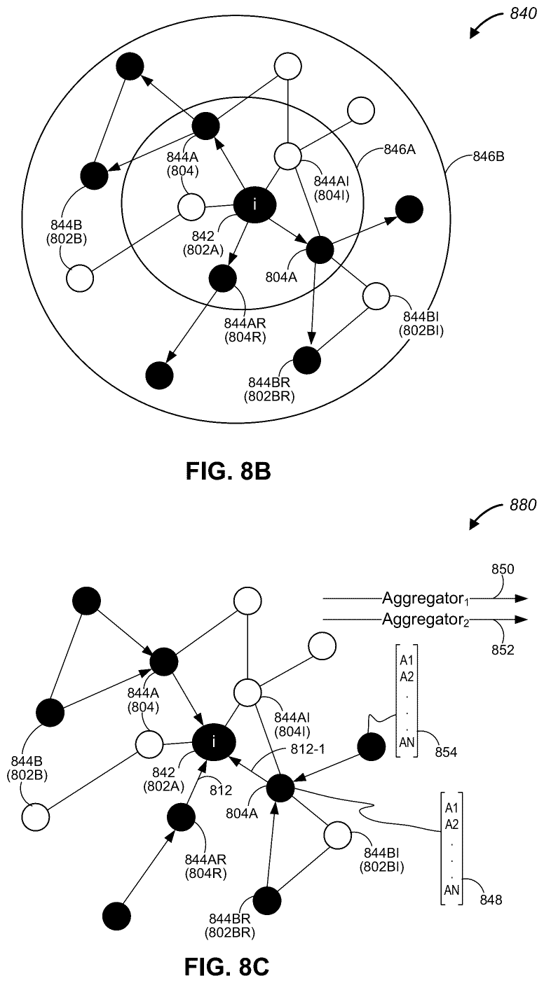

More details on operations of the item ranking module 222 are explained below with reference to FIGS. 8A-14.

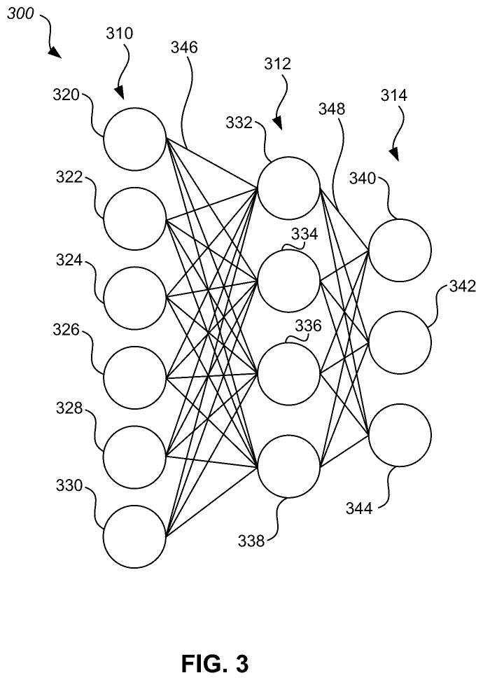

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here, xᵢ⁽ⁿ⁾ denotes the value of the i-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 320-338 of the m-th layer 310, 312 and the j-th node 332-344 of the n-th layer 312, 314. Furthermore, the abbreviation w_{i,j}⁽ⁿ⁾ is defined for the weight w_{i,j}^{(n,n+1)}.

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values w_{i,j}^{(m,n)} for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )} \qquad ( 1 )$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} ) \qquad ( 2 )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} ) \qquad ( 3 )$$

if the (n+1)-th layer is the output layer 34, wherein f′ is the first derivative of the activation function, and γⱼ⁽ⁿ⁺¹⁾ is the comparison training value for the j-th node of the output layer 314.

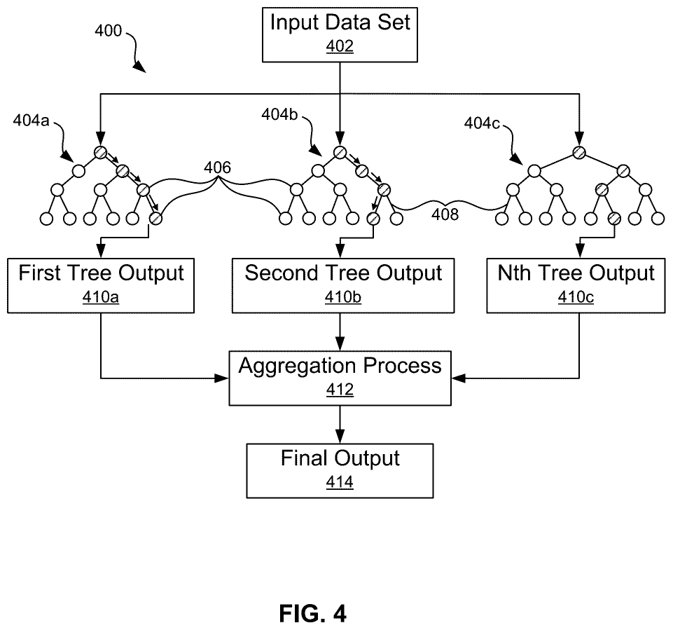

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

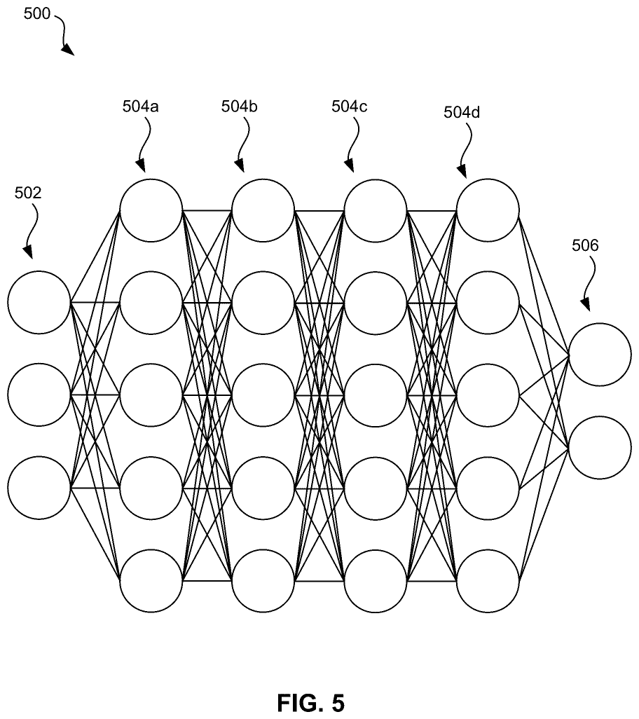

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ] \qquad ( 4 )$$

where a^{(l)}(x) is a preactivation function and h^{(l)}(x) is a hidden-layer activation function providing the output of each hidden layer. The preactivation function a^{(l)}(x) may include a linear operation with matrix w^{(l)} and bias b^{(l)}, where:

$${a}^{( l )} ( x ) = {W}^{( l )} x + {b}^{( l )} \qquad ( 5 )$$

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} ) \qquad ( 6 )$$

where β is an offset and each fᵢ is parametrized by a neural network. In some embodiments, the DNN 500 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )} \qquad ( 7 )$$

where d represents one or more features of the independent variable x.

It will be appreciated that automated item ranking and presentation, as disclosed herein, particularly for large platforms such as e-commerce network platforms, is only possible with the aid of computer-assisted machine-learning algorithms and techniques, such as the disclosed graph-based relevance model 224. In some embodiments, item ranking processes including the trained graph-based relevance model 224 are used to perform operations that cannot practically be performed by a human, either mentally or with assistance, such as automated determination of a relevance level of a query and an item and ranking of a plurality of items associated with the query into an ordered item list using a graph-based relevance model 224. It will be appreciated that a variety of item ranking techniques can be used alone or in combination to determine a relevance level of a query and an item and rank a plurality of items associated with the query into an ordered item list using a graph-based relevance model 224.

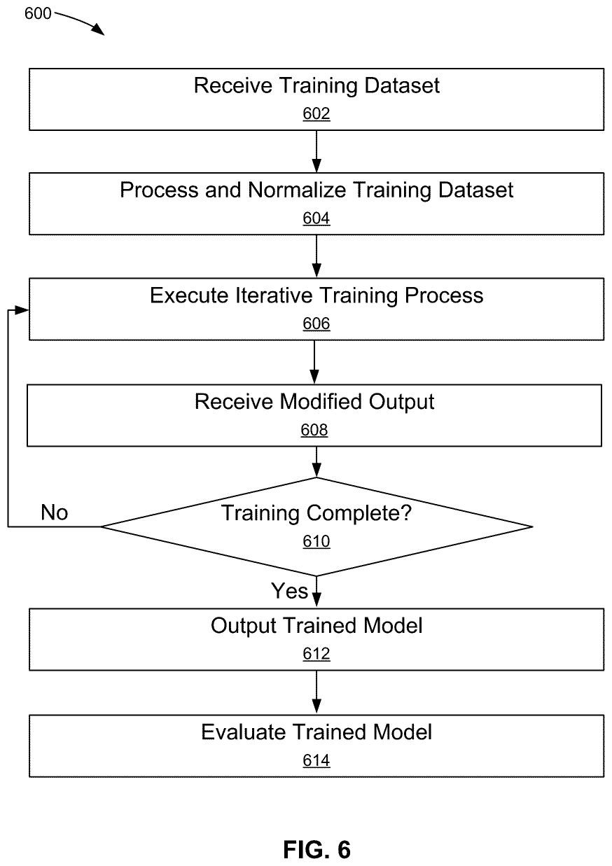

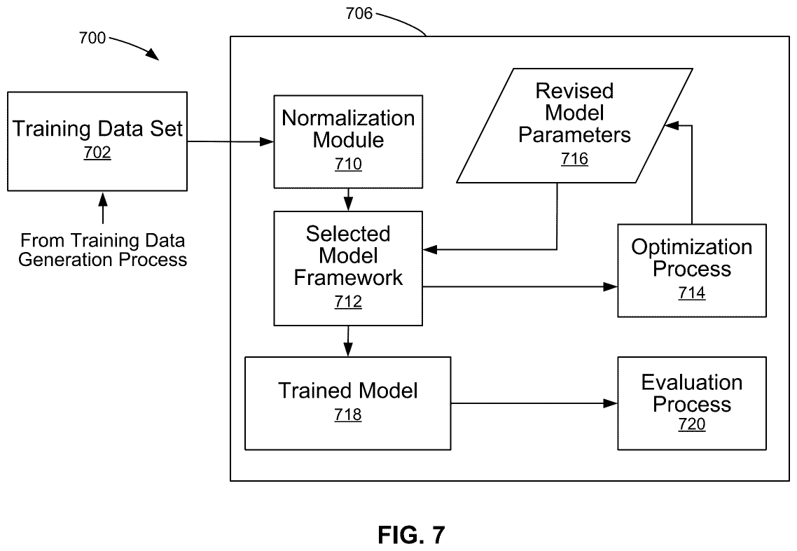

In some embodiments, an item ranking method can include and/or implement one or more trained models, such as a trained graph-based relevance model 224. In some embodiments, one or more trained models can be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a graph-based relevance model 224 in FIG. 2), in accordance with some embodiments. At step 602, a training dataset 702 is received by a system 706, such as a processing device 120. The training dataset 702 can include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 can be augmented by imputing or estimating missing values or features of one or more screenshots.

At step 606, an iterative training process is executed to train a selected model framework 712. The selected model framework 712 can include an untrained (e.g., base) graph-based relevance model 224, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 can be generated by applying an optimization process 714 to the cost function of the selected model framework 712. The optimization process 714 can be configured to reduce the cost value (e.g., reduce the output of the cost function) at each step by adjusting one or more parameters during each iteration of the training process.

After each iteration of the training process, at step 610, a determination is made whether the training process is complete. The determination at step 610 can be based on any suitable parameters. For example, in some embodiments, a training process can complete after a predetermined number of iterations. As another example, in some embodiments, a training process can complete when it is determined that the cost function of the selected model framework 712 has reached a minimum, such as a local minimum and/or a global minimum.

At step 612, a trained model 718 is output and provided for use in determining query-item ranking and/or ranking items. At optional step 614, a trained model 718 can be evaluated by an evaluation process 720. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

FIG. 8A is a flow diagram of a process 800 of determining relevance levels 810 between queries 802 and items 804, in accordance with some embodiments. A computing device 200 (e.g., see FIG. 2) executes a user application 218 for receiving user queries 802 (e.g., 802-1 to 802-4) from users and providing relevant information items 804 (e.g., 804-1 to 804-4) in response to the queries 802. For example, each information item 804 is configured to provide information concerning a product or service sold via the user application. In some embodiments, a query 802 (e.g., 802-1) was previously received from one or more respective former users, and one or more information items 804 (e.g., 804-1) were provided to the respective former users in response to the respective query 802. An information item 804 (e.g., 804-1) was also provided to one or more former users in response to one or more respective queries 802 (e.g., 802-1 and 802-2). For example, in response to a first query 802-1, the user application 218 provides a plurality of information items including a first item 804-1, and the first item 804-1 was previously provided to, and engaged by, a corresponding former user in response to at least a second query 802-2. In some embodiments, the user queries 802 includes an isolated query 802-4 to which no information item 804 is identified and provided in response. In some embodiments, the information items 804 includes an isolated item 804-4 that has not been provided to any user query 802.

A bipartite engagement graph 806 is established between queries 802 and items 804 based on historic user engagement on the user queries 802 and items 804. Example user engagement includes user clicks, add-to-cart, and orders of an item presented in response to a query. Each connecting line 808 in the bipartite engagement graph 806 corresponds to a query-item pair, and represents that the item 804 of the query-item pair has been at least presented in response to the query 802 in the same query-item pair. In some embodiments, a relevance level 810 (also called a similarity level) is further determined for each query-item pair based on associated user engagement that occurs to the item 804 as the item 804 is presented in response to the corresponding query 802 in the same query-item pair. Further, in some embodiments, the relevance level 810 is marked adjacent to each of one or more connecting lines 808 in an updated engagement graph 806′. For example, the relevance level 810 is defined in a range of [A, B] (e.g., [−1, 1], [0, 1]), where a first value of B represents a highest relevance level and a second value of A represents a lowest relevance level. For each query-item pair, the higher the relevance level 810, the higher a likelihood of user engagement with the item 804 in response to the associated query 802. Additionally, in some embodiments, a plurality of information items 804 are identified in response to the same query 802. The same query 802 has a respective relevance level 810 associated with each of the plurality of information items 804, and the plurality of information items 804 are ranked according to the respective relevance levels 810 into an ordered item list.

In some embodiments, an engagement log is created to record information of user engagement with items 804 presented in response to a set of queries 802. A first subset of the item 804 corresponds to products with click-through data. In some embodiments, the click-through data results correspond to the connecting lines 808 which are solid, indicating that an item 804 is selected as a query result (e.g., for orders) and the item 804 corresponds to the largest relevance level (e.g., B) in a range of [A, B]. A second subset of the items 804 corresponding to products without click-through data and each of these products is optionally clicked for review, highlighted for a cursor pause, or not engaged by any user interaction. The engagement graph 806′ is established based on the set of queries 802, the first subset of items 804, and the second subset of items 804. The engagement graph 806′ includes embeddings associated with nodes representing the queries 802 and the items 804, and therefore, forms a directional bipartite graph containing two sets of nodes including a set of item nodes corresponding to the first subset of the items 804 and the second subset of the items 804 and a set of query nodes corresponding to the set of queries 802. A query 802 is connected to an item 804 through a connecting line 808, if there has been user engagement associated with the corresponding query-item pair. In some embodiments, based on different types of user engagement, a directional edge is formed between the query 802 and item 804 of a query-item pair, and is associated with the relevance level 810. Stated another way, in some embodiments, the engagement graph 806′ includes both edges having weights from queries to items, w_{q→p}, and edges having weights from items to queries, w_{p→q}. The weights are determined based on user engagement with the items 804 presented in response to the queries 802, and applied to identify relevant neighboring nodes for each query or item node in the bipartite engagement graph 806.

In some embodiments, most items 804 are not selected as query results, thereby resulting in a sparsity of the click-through data and a lack of embeddings for unengaged items. This may cause a long-tail problem, which is common in information retrieval, and could lead to poor performance on cold start items 804 and reinforce a rich-get-richer effect. In some embodiments of this application, the engagement graph 806′ is generated with embeddings for both of the first subset of the items 804 and the second subset of the items 804 during the inference thereby addressing the long-tail problem.

FIGS. 8B and 8C are schematic diagrams of two example engagement graphs 840 and 880, in accordance with some embodiments. The engagement graphs 840, 880 connect a collection of items 804 and a collection of queries 802 to each other. Each of the engagement graphs 840, 880 include a central query node 842 representing a first query 802A and vertices 844A and 844B that are distinct from the central query node 842 and split into two independent groups. A first group of vertices 844A represent a collection of items 804 that are provided in response to, and directly connected in the engagement graphs 840, 880 to, the first query 802A. A second group of vertices 844B represents a collection of second queries 802B, to which the collection of items 804 are directly connected in the engagement graphs 840, 880 and provided in response. For case of reference, referring to FIG. 8B, the first group of vertices 844A and the central query node 842 are enclosed in a first circle 846A corresponding to a first layer (K=1) of embeddings (e.g., feature vectors) and the second group of vertices 844B are excluded from the first circle 846A and enclosed within a second circle 846B corresponding to a second layer (K=2) of embeddings (e.g., feature vectors).

In some embodiments, the engagement graph 840, 880 is updated periodically, according to a predefined schedule, or in response to a user request, as queries 802 are received and items 804 are provided in response to the queries 802 on a user application 218 (see, e.g., FIG. 2). For example, the engagement graph 840, 880 may be updated every night at 12 AM at an item ranking computing device 102 or cloud-based engine 121. Further, in some embodiments, the first query 802A represented by the central query node 842 did not exist at a last update and is newly received after a last update corresponding to the engagement graph 840, 880. Alternatively, in some embodiments, at least one of the second queries 802B and the items 804 did not exist at a last update and is newly received after a last update corresponding to the engagement graph 840, 880. Alternatively, in some embodiments, the engagement graph 840, 880 includes the first query 802A, the collection of items 804, and the collection of second queries 802B at a last update. After the last update, one or more engagement relationships have been updated between the first query 802A and the collection of items 804 and/or between an item 804 and the collection of second queries 802B. For example, one of the collection of items 804 is clicked through with a smaller weight in response to one of the queries 802A and 802B.

In some embodiments, at an update, the engagement graph 840, 880 corresponds to user engagement data of query-items collected for the user application 218 during an extended duration of time (e.g., four years). Each item 804 in the collection of items 804 is selected in accordance with a determination of at least one of the following conditions including (1) that a number of times when the respective item 804 is selected as a query result (e.g., clicked through) is greater than a first time (e.g., 2) and (2) a number of times when the respective item 804 is selected for review is greater than a second number (e.g., 1). An edge weight weight(q, p) is determined for each query-item pair based on a number of user interactions (e.g., numbers of impressions, clicks, add-to-carts (atcs), and/or orders (e.g., selection as query result)) as follows:

$$weight ( q , p ) = \frac{4 * {orders}^{2} + 2 * {atcs}^{2} + {clicks}^{2}}{impressions + 4} \qquad ( 8 )$$

where the numbers of clicks (clicks) and add-to-carts (atcs) are emphasized to indicate a stronger signal about the connectivity between a query 802 and an item 804. The number of impressions (impressions) refers to the number of times that the item is displayed and viewed in response to a query (q). For a query 802(q) and an item 804(p), directional edge weights from the query to items (w_{(q→p)}) and from the item 804 to queries 802 (w_{(p→q)}) are determined by normalizing edge weights weight(q,p) using a sum of the edge weights of all nodes connected to the query q and the item p, respectively, as follows:

$$w ( q \to p ) = \frac{weight ( q , p )}{{\sum }_{i ∈ 𝒩 ( q )} weight ( q , i )} , \qquad ( 9 )$$

$$w ( p \to q ) = \frac{weight ( q , p )}{{\sum }_{i ∈ 𝒩 ( p )} weight ( i , p )} , \qquad ( 10 )$$

where N (g) represents a set of neighboring nodes of a query node 842, and N (p) represents a set of neighboring nodes of a vertex 844A representing an item 804.

In some embodiments, each item 804 in the collection of items 804 has been engaged with users when provided to the users in response to the first query 802A. A plurality of items 804R are selected from the collection of items 804 based on an edge weight (e.g., engagement weight) of each of the plurality of items. For example, the plurality of items 804R are represented by dark vertices 844AR in the engagement graphs 840, 880, and remaining unselected items 8041 are represented by open vertices 844AI. Specifically, in some embodiments, the edge weight of each of the plurality of items 804R is based on one or more of a number of times when the respective item 804R is selected as a query result (e.g., orders), a number of times when the respective item 804 is selected for review (e.g., clicks), a number of times when the respective item 804R is selected as a candidate result (e.g., atcs), and a number of times when the respective item 804R is associated with a cursor hovering action during a duration of time (e.g., four years). Further, in some embodiments, the plurality of items 804R includes no more than a predefined number of items (e.g., 3 items, 20 items) in the collection of items 804R. For example, the collection of items 804 may have 5 items and all 5 items may be selected. In another example, the collection of items 804 may have 5 items and 3 items having the largest edge weights are selected to be associated with the first query 802A.

In some embodiments, each item 804 in the collection of items 804 (e.g., 804R, 8041, 804A) has also been engaged with users when provided to the users in response to a subset of the collection of second queries 802B (e.g., 802BR, 802BI). For each item 804, one or more second queries 802BR are selected from the collection of queries 802B based on their edge weights associated with the respective item 804. A plurality of second queries 802BR are represented by dark vertices 844BR in the engagement graphs 840, 880, and remaining unselected queries 802BI are represented by open vertices 844BI. Further, in some embodiments, for each item 804R, the one or more second queries 802BR include no more than a predefined number of second queries 802BR (e.g., 2 queries, 20 queries) in the collection of queries 802B. For example, the collection of queries 802B has 3 queries to which a first item 804A is identified in response, and all 3 queries are selected for the first item 804A. In another example, the collection of queries 802B has 3 queries to which the first item 804A is identified in response, and 2 queries associated with the largest edge weights are selected for the first item 804A.

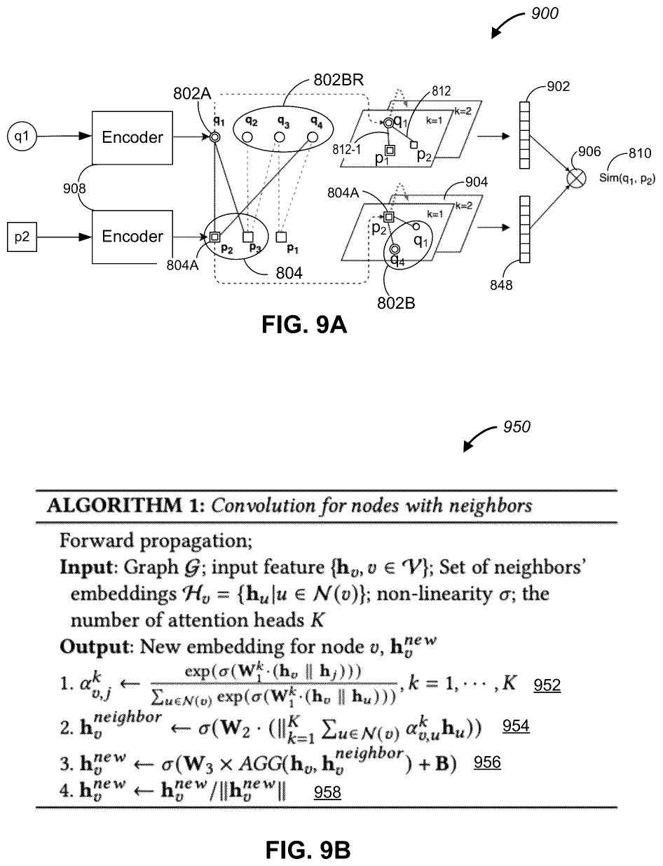

A plurality of messages 812 are determined for the plurality of items 804R and communicated to the central query node 842 representing the first query 802A on the engagement graph 840, 880. The plurality of items 804R includes a first item 804A, and a first message 812-1 is determined for the first item 804A based on a plurality of second queries 802BR. In some embodiments, the first item 804A has a respective query feature vector 854 for each of the plurality of second queries 802BR, and the first message 812-1 of the first item 804A is determined by combining (operation 850) the respective query feature vectors 854 of the plurality of second queries 802BR associated with the first item 804A using semantic weights. A query feature vector (e.g., 902 in FIG. 9A) then is determined (operation 852) for the first query 802A based on the plurality of messages 812 including the first message 812-1, and applied to rank the plurality of items 804R associated with the first query 802A into an ordered item list.

In some embodiments, each of the engagement graphs 840, 880 includes a number of layers, and the number is greater than 2. Each of a set of second queries 802B on the second circle 846B is connected to one or more items on a third layer not shown on FIGS. 8B and 8C, and each of a set of items on the third layer is connected to one or more queries on a fourth layer (not shown). Stated another way, each of a set of query or item nodes on a certain layer is connected to one or more item or query nodes that are located on a neighboring layer and selected based on associated edge weights. Each of the set of query or item nodes on the certain layer has a respective feature vector that is determined by combining the respective feature vectors associated with the one or more item or query nodes on the neighboring layer using semantic weights (e.g., in formulas 950 of FIG. 9B).

FIG. 9A is a flow diagram of an example process 900 of determining a relevance level 810 between a query 802 (q1) and an item 804 (p2), in accordance with some embodiments. FIG. 9B is a diagram showing example formulas 950 for determining the relevance level 810 between a query and an item, in accordance with some embodiments. An item ranking computing device 102 identifies a plurality of items 804R (e.g., p2 and p3) to be provided in response to a first query 802A (e.g., q1), and the plurality of items 804R include a first item 804A (e.g., p2) that was previously engaged by at least one prior user in response to a plurality of second queries 802BR (e.g., q4). The item ranking computing device 102 determines a plurality of messages 812 for the plurality of items 804R associated with the first query 802A, and a first message 812-1 of the first item 804A based on the plurality of second queries 802BR. A query feature vector 902 of the first query 802A is determined based on the plurality of messages 812 including the first message 812-1 of the first item 804A. The item ranking computing device 102 ranks the plurality of items 804R associated with the first query 802A into an ordered item list based on the query feature vector 902. In response to receiving the first query 802A from a next user, the item ranking computing device 102 presents information of the plurality of items 804R based on the ordered item list on a screen of an electronic device associated with the next user.

In some embodiments, the item ranking computing device 102 determines the relevance level 810 between the first query 802A and each of the plurality of items 804R based on the query feature vector 902. The plurality of items 804R are ranked for the first query 802A based on the relevance level 810 associated with each of the plurality of items 804R. Further, in some embodiments, an item feature vector 848 is determined for each of the plurality of items 804R. The relevance level 810 between the first query 802A and each of the plurality of items 804R is determined based on the query feature vector 902 and the item feature vector 848 of the respective item 804. For example, for each of the plurality of items 804R, the relevance level 810 is determined based on a dot product 906 of the query feature vector 902 and the item feature vector 848 of the respective item 804. Additionally, in some embodiments, the computing device 200 determines the item feature vector 848 of the first item 804A by identifying the plurality of second queries 802BR (e.g., q1 and q4) to which the first item 804A is provided in response. For each of the plurality of second queries 802BR associated with the first item, the computing device 200 determines a respective message of the respective second query 802BR by combining a plurality of item features of a plurality of second items (e.g., on a layer 904 (k=2)) provided in response to the respective second query 802BR. The item feature vector 848 of the first item 804A is determined based on the respective messages of the plurality of second queries 802BR. The first item 804A is ranked in the plurality of items 804R associated with the first query 802A based on the query feature vector 902 of the first query 802A and the item feature vector 848 of the first item 804A.

In some embodiments, the item ranking computing device 102 leverages a two-level structure to find initial embeddings (e.g., feature vectors) of queries 802 and items 804, and applies every node's local neighbors and input information to generate final embeddings. Stated another way, the process 900 leverages input features and uses neural network transformation and aggregation layers to enrich embedding of each node through its neighbors' information. An encoder network 908 is applied to extract a feature vector from each of the queries 802 and items 804 to provide an input feature. For items 804 related to products, the input feature is constructed based on product information including product title and/or product attributes (such as product type, color, gender, and brand). For queries 802, the query text is applied to construct the input feature. An example encoder network 908 includes DistillBERT, which includes six layers and 256 embedding size and is fine-tuned on a custom dataset. Referring to FIG. 9B, in some embodiments, the query feature vector 902 (hᵥ^{new}) of the first query 802A is determined based on the plurality of messages 812 (hᵥ^{neighbor}) and the input feature (hᵥ) extracted from the first query 802A by the encoder network 908. In some embodiments, the item feature vector 848 of each item 804 is determined based on the respective messages of the plurality of second queries 802BR and the input feature extracted from the respective item 804 by the encoder network 908. The respective messages of the second queries 802BR are associated with a respective query feature vector 854 determined for each of the plurality of second queries 802BR. By these means, the representations of the query 802 (q∈Q) and the item 804 associated with a product (p∈P) may be enriched by considering the representation of their neighboring nodes.

Referring to FIG. 9B, in some embodiments, the item ranking computing device 102 generates the embedding of nodes which exists in the engagement graph 840, 880 using their input features and neighbors in the graph structure. The intuition behind the formulas 950 is to find the neighbors of the node v and propagate their information into the embedding of the target node 842. A graph-based relevance network 228 (see FIG. 2) is applied to determine the relevance level 810 of each item 804 with respect to the first query 802A. The engagement graph 840, 880 includes K attention layers, where K is an integer greater than 1. Optionally, top 20 neighbors are sampled on each layer based on edge weights (also called engagement weights) that are determined using equations (8)-(10). Semantic weights a_{v,j}^{k} are determined (operation 952) for each attention layer, and applied to derive (operation 954) the plurality of messages 812. The plurality of messages 812 are combined (operation 956) with the feature vector (hr) extracted from the first query 802A by the encoder network 908 to generate the query feature vector 902 (hᵥ^{new}), which is further normalized (operation 958).

In some embodiments, in these forward propagation steps for nodes with neighbors, the semantic weights a_{v,j}^{k} between the target node 842 and its neighboring vertices 844A are generated by concatenating their embedding and leveraging a feed forward layer (σ(w₁^{k}·(hᵥ∥hⱼ))). A softmax function is applied to normalize these weights over all neighbors of the node in the sample set and generate use K number of attention heads to stabilize a corresponding learning process. The computing device 200 computes the weighted average of the neighbors' embeddings using a_{v,u}^{k} for every attention head and concatenates them to determine the messages 812 from the neighbors. Finally, the item ranking computing device 102 aggregates the embeddings of neighbors hᵥ^{neighbor} with the node initial embedding hᵥ (e.g., the input feature (hr) extracted from the first query 802A by the encoder network 908) using an AGG function and a dense neural network layer. The output embedding corresponding to the query feature vector 902 (hᵥ^{new}) is normalized to enhance stability of the graph-based relevance model 288 during training.

In some embodiments, the plurality of items 804 include an isolated item that was not previously provided in response to any query. The item ranking computing device 102 applies the encoder network 908 to generate an item feature vector 848 of the isolated item. A new message 812 of the isolated item is determined based on the item feature vector 848 of the isolated item, and the plurality of messages 812 including the new message are combined to determine the query feature vector 902 of the first query 802A. Stated another way, the isolated item does not receive engagement from any user. In some embodiments, a pseudo second query 802BR is defined for the isolated item, and the new message 812 is generated using the pseudo second query 802BR. In an example, the pseudo second query 802B is an item title of the isolated item.

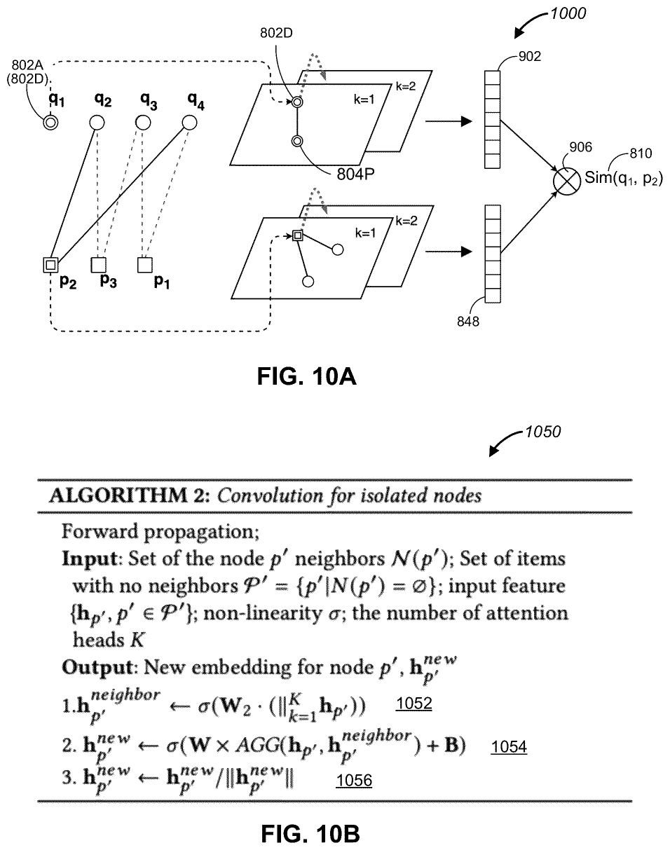

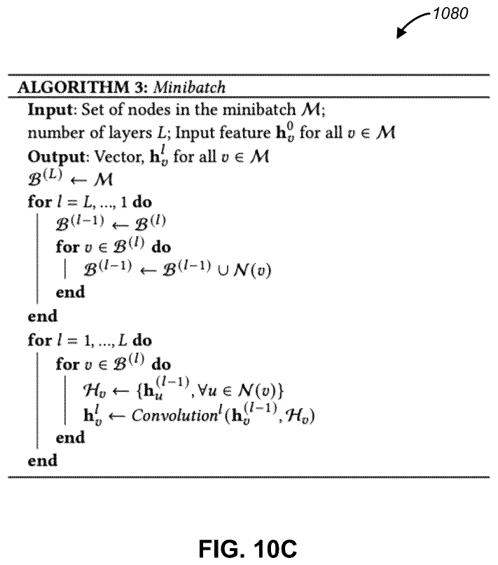

FIG. 10A is a flow diagram of an example process of determining a relevance level between an isolated query 802D and an item 804, in accordance with some embodiments. FIG. 10B is a diagram showing example formulas for determining the relevance level 810 between an isolated query 802D shown in FIG. 10A and an item 804, in accordance with some embodiments. The isolated query 802D is a new query that was not previously used by any user, and therefore, not associated with any item 804 in engagement logs. A item ranking computing device 102 extracts one or more pseudo items 804P associated with the isolated query 802D (e.g., using an item title in the query), and apply the extracted pseudo items 804P as pseudo neighbors of the isolated query 802D. In some embodiments, forward propagation is applied for isolated nodes on the engagement graph 840, 880. Embeddings are generated for isolated nodes. Since isolated nodes (e.g., item 804D) are not connected to any neighbors in the graph, the item ranking computing device 102 uses each pseudo items 804P as a pseudo neighbor and leverage its embedding (e.g., h_{p′}) as the representation of neighbors and pass it through a neural network layer. The item ranking computing device 102 aggregates the embeddings of neighbors h_{p′}^{neighbor} with the node embedding h_{p′} through an AGG function and a dense neural network layer, before the aggregated embedding (e.g., feature vector) is normalized.

In some embodiments, and with reference to FIG. 10B, in accordance with a determination that the first query 802A is an isolated query 802D to which no item 804 was previously provided in response, the item ranking computing device 102 extracts one or more pseudo items 804P from the isolated query 802D. Feature vectors h′ₚ are extracted from the isolated query 802D including the one or more pseudo items 804P. Semantic weights a_{v,j}^{k} are determined as 1 for each attention layer, and applied to derive (operation 1052) the plurality of messages 812 corresponding to the pseudo items 804P. The plurality of messages 812 are combined (operation 1054) with the feature vector h′ₚ extracted from the first query 802A by the encoder network 908 to generate the query feature vector 902 h_{p′}^{new}), which is further normalized (operation 1056).

FIG. 10C is a diagram showing example program codes 1080 for applying neighbor sampling to compute feature vectors at every layer of an engagement graph 840, 880, in accordance with some embodiments. In response to each first query 802A, a collection of items 804 is provided. A plurality of items 804R is selected as neighboring nodes of the respective query 802A from the collection of items 804 based on edge weights (also called engagement weights) on an engagement graph 840, 880. These neighboring nodes are further ranked based on associated semantic weights that are determined based on their associated second queries 802BR. Stated another way, for each first query 802A, the edge weights determined using equations (8)-(10) are applied to select relevant items 804R, and the semantic weights determined in operation 952 (FIG. 9B) are applied to rank the selected items 804R. In some embodiments, the item ranking computing device 102 applies the formulas 950 and 1050 to stack the representation of the neighbors of every node l-hop away from the target node 842 corresponding to a first query 802A, thereby gathering more information about the target node 842 by stacking multiple layers (e.g., l layers).

Referring to FIG. 10C, the program codes 1080 describe a plurality of layers of convolution where the representation of a node at layer l depends on the output from the layer l−1 (with the l=0 representing the input feature of a first query 802A). The model parameters W₁, W₂, W₃, B are shared for all nodes on the same layer of a graph-based relevance model 224, and different across different neural network layers. For instance, B^{(l-1)} contains all nodes that are needed to calculate the representation of nodes at layer l. The representation of each node at layer l, hᵥ^{l} is the convolution of its neighbors' embeddings, H_v, and the representation of the node at layer l-1, hᵥ^{(l-1)}. Learnable weights may include a bias B and weight parameters W₁, W₂, and W₃ at each layer l.

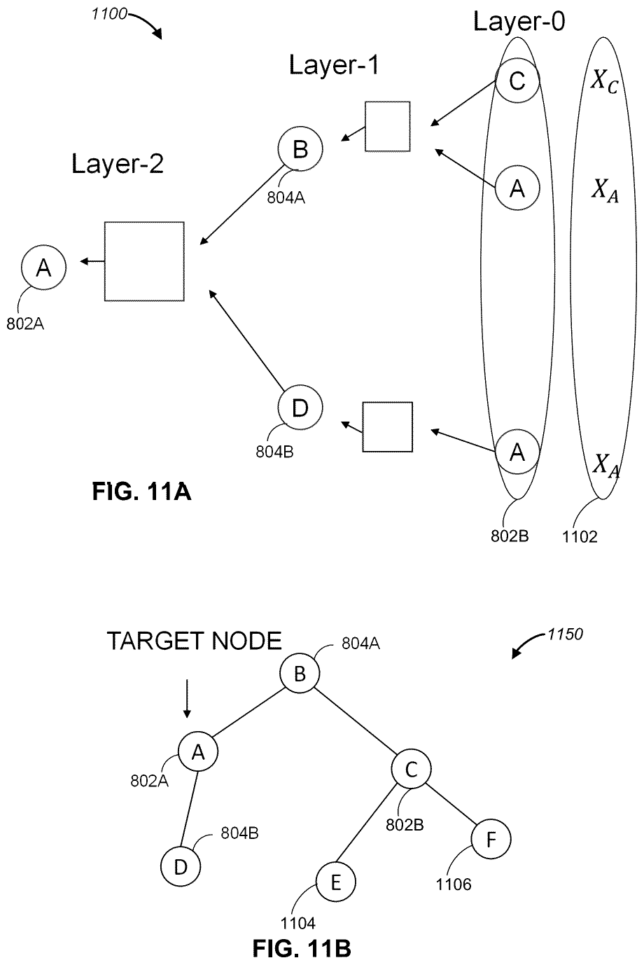

FIG. 11A is a structural diagram of an engagement graph 1100 of a first query 802A, in accordance with some embodiments. FIG. 11B is a structural diagram of an input graph 1150 consolidated from the engagement graph shown in FIG. 11A, in accordance with some embodiments. The engagement graph 1100 includes three layers, Layer-0, Layer-1, and Layer-2 and follows an information aggregation and forward propagation rule. In accordance with the rule, Layer-0 includes input features 1102 of a collection of items 804 or queries 802. For items 804 related to products, the input feature is constructed based on product information including product title and/or product attributes (such as product type, color, gender, and brand). For queries, the query text is applied to construct the input feature. In an example, Layer-2 includes the first query 802A, and Layer-1 includes a collection of items 804. Layer-0 therefore includes a collection of second queries 802B to which the collection of items 804 is provided in response. On Layer-0, the input features X_{A} and X_{C} are extracted from the second queries 802B, e.g., using an encoder network 908 (FIG. 9A). Further, in accordance with the information aggregation and forward propagation rule, Layer-1 includes item or query nodes that receive information from Layer-0 nodes that is 1-hop away. For example, Layer-1 includes item nodes corresponding to the collection of items 804. A node of a first item 804A receives the input features X_{A} and X_{C} of two second queries, and a node of a second item 804B receives the input feature X_{A} of a second query. Additionally, in accordance with the information aggregation and forward propagation rule, Layer-2 includes item or query nodes that receive information directly from Layer-1 nodes that is 1-hop away and indirectly from Layer-0 nodes that is 2-hop away. A node of first query 802A receives messages 812 from the nodes of items 804, which receives the input features X_{A} and X_{C} of the plurality of second queries 802B.

Each item or query node has an initial embedding (e.g., input feature). For items related to products, the input feature may be constructed based on product information including product title and/or product attributes (such as product type, color, gender, and brand). For queries, the query text may be applied to construct the input feature. Initial embedding of a node at a first layer (e.g., Layer-1) is combined with information received from a neighboring layer (e.g., Layer-0) to determine a subset of semantic weights, messages 812, item feature vectors 848, and query feature vector 902. Referring to FIG. 11B, in some embodiments, the input graph 1150 is consolidated from FIG. 11A based on edge weights of each query-item pair. For Layer-1, no node on Layer-0 is selected for the items 804B, and a single node 802B is selected on Layer-0 is selected for the item 804A. The single node 802B on Layer-0 is further determined based on item feature vectors of two items 1104 and 1106.

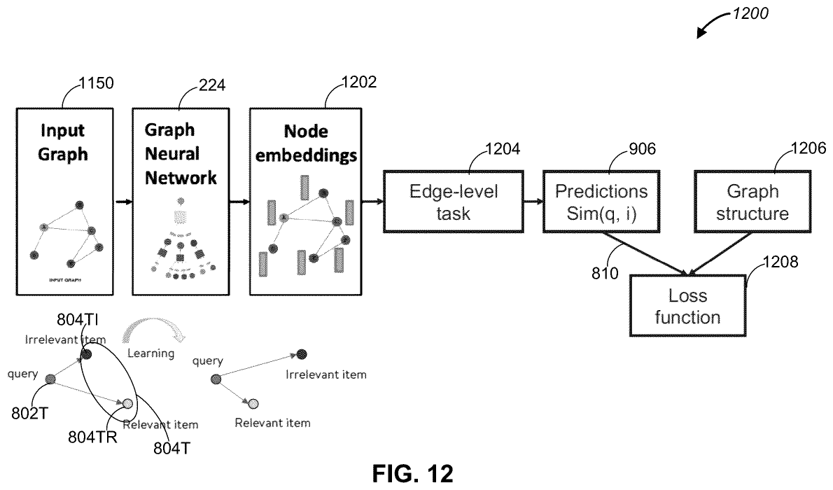

FIG. 12 is a block diagram of a model training module 1200 for training a graph-based relevance model 224, in accordance with some embodiments. For example, the graph-based relevance model 224 may correspond to an engagement graph 1100 that is consolidated to an input graph 1150. The input graph 1150 and the graph-based relevance model 224 are applied to determine node embeddings 1202 that include query feature vectors 902 of first queries 802A and item feature vectors 846 of items 804. For each first query 802A, the query feature vector 902 is determined based on a plurality of messages 812 received from the plurality of items 804R associated with the first query 802A, and for each item 804R, the respective message 812 is determined based on a plurality of second queries 802BR to which the respective item 804 is identified in response. In some embodiments, an item feature vector 848 is determined for each of the plurality of items 804R. After the query feature vector 902 and item feature vector 848 are determined on an edge level 1204, the relevance level 810 between the first query 802A and each of the plurality of items 804R is determined based on the query feature vector 902 and the item feature vector 848 of the respective item 804. For example, for each of the plurality of items 804R, the relevance level 810 is determined based on a dot product 906 of the query feature vector 902 (see FIG. 9A) and the item feature vector 848 of the respective item 804. In some embodiments, ground truth 1206 is determined based on a graph structure of the input graph 1150, and the relevance level 810 is compared with the ground truth 1206 to determine a loss function 1208 (e.g., a triplet loss). Learnable weights include a bias B and weight parameters W₁, W₂, and W₃, and are iteratively adjusted until the loss function 1208 satisfies a predefined criterion (e.g., falls below a loss limit, is minimized).

In some embodiments, the graph-based relevance model 224 is applied to determine the relevance level 810 of the first query 802A with each of the plurality of items 804R. The graph-based relevance model 224 is trained using a collection of training queries 802T, a collection of training items 804T, and a triplet loss. Each training query 802T corresponds to a set of relevant training items 804TR and a set of irrelevant training items 804TI. The triplet loss is a way to teach the graph-based relevance model 224 to recognize the similarity or differences between queries 802T and training items 804T, and uses groups of three items, called triplets, which consist of an anchor query 802T, a relevant training item 804TR, and an irrelevant item 804TI. The graph-based relevance model 224 is trained to increase a relevance level 810 between a training query 802T and a relevant training item 804TR, and decrease a relevance level between a training query 802T and an irrelevant training item 804TI. Stated another way, the graph-based relevance model 224 is trained to decrease a distance between a training query 802T and a relevant training item 804TR, and increase a distance between a training query 802T and an irrelevant training item 804TI.

In some embodiments, the loss function 1208 encourages that dissimilar pairs become distant from any similar pairs by at least a predefined margin. For every training query 802T, a relevant training item 804TR and an irrelevant item 804TI are selected to leverage the triplet loss to learn the parameters W₁, W₂, W₃, and B. For example, the loss function 1208 for the vector of a positive pair of nodes (h_{q}, hₚ⁺) is represented as follows:

$$\begin{matrix}𝒥 ( G ) = {E}_{{n}_{p} - ∼ {𝒫}_{u} ( q )} J ( q , {p}^{+} , {p}^{-} ) \\ J ( q , {p}^{+} , {p}^{-} ) = {β}_{q , {p}^{+}} max ( 0 , sim ( {h}_{q} , {h}_{{p}^{-}} ) - sim ( {h}_{q} , {h}_{{p}^{+}} ) + Δ ) ) \\ {β}_{q , {p}^{+}} = \frac{1}{2} \{ w ( q \to {p}^{+} ) + w ( {p}^{+} \to q ) \} ,\end{matrix} \qquad ( 11 )$$

where Pₙ(q) denotes the distribution of the negative examples for the query q and δ denotes the predefined margin, which is a hyperparameter. In some embodiments, the item ranking computing device 102 increases a similarity level or a relevance level between the queries 802T and training items 804T with stronger connections in the graph compared to items 804 with weaker links. A parameter β_{q,p}+ is introduced to represent the average weights between the query 802T and the relevant training item 804TR in the engagement graph. In some embodiments, negative samples (e.g., irrelevant training items 804TI) are applied in equation (11) for model training. For example, the item ranking computing device 102 samples 500 irrelevant training items 804TI to be shared by all queries 802T in a minibatch. In some embodiments, these irrelevant training items 804TI are randomly selected among the set of irrelevant training items 804TI not linked to queries 802T in the minibatch, and a chance of selecting competitive irrelevant items 804TI that can help the graph-based relevance model 224 learn the parameters more effectively could be small. In some embodiments, only the hardest irrelevant items 804TI are selected in each mini batch for each query-item pair.

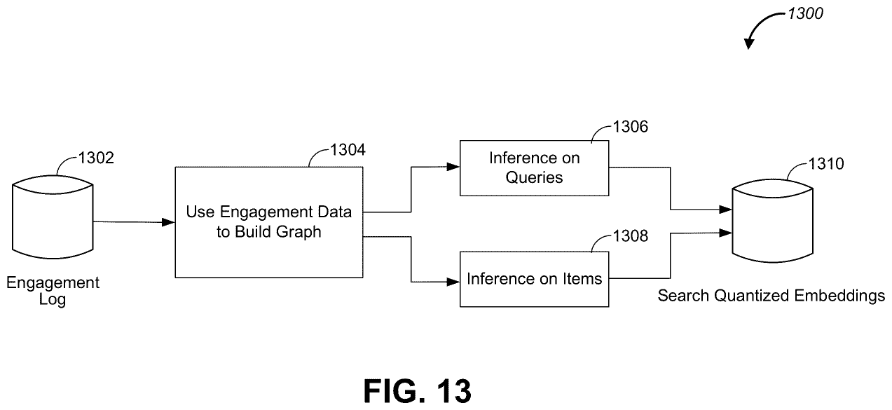

FIG. 13 is a flow diagram of an example process 1300 for inferring items 804 and queries 802 and updating node embeddings 1202 in an engagement graph 840, 880, in accordance with some embodiments. A computing device obtains an engagement graph 840, 880 connecting a collection of items 804 and a collection of queries 802B to each other. The engagement graph is optionally updated periodically, according to a predefined schedule, in response to a user request and/or in accordance with a determination that an update condition is satisfied (e.g., detection of a change in neighboring nodes or features on the engagement graph). In some embodiments, a first query 802A is newly received after a last update of the engagement graph 840, 880. A plurality of items 804R are identified for the first query 802A, and a plurality of second queries 802BR are identified for the plurality of items 804R. Alternatively, in some embodiments, the engagement graph includes the first query 802A, the plurality of items 804R, and the plurality of second queries 802BR at the last update. After the last update of the engagement graph, one or more engagement relationships have been updated between the first query 802A and the plurality of items 804R and/or between the first item 804A (see FIGS. 8B and 8C) and the plurality of second queries 804BR. In an example, the engagement graph 840, 880 is updated daily to incorporate new queries 802 and items 804 and renew engagement data associated with existing query-item pairs.

In some embodiments, an engagement log 1302 is created to record information of user engagement with items 804 presented in response to a set of queries 802. At an update, the engagement graph 840, 880 may be built (operation 1304) using user engagement data of query-items collected for a user application 218 (FIG. 2) during an extended duration of time (e.g., four years). In some embodiments, each item 804 in the collection of items 804 is selected in accordance with a determination of at least one of the following conditions including (1) that a number of times when the respective item 804 is selected as a query result (e.g., clicked through) is greater than a first time (e.g., 2) and (2) a number of times when the respective item 804 is selected for review is greater than a second number (e.g., 1). For query inference 1306 at the update, the query feature vector 902 may be generated for each new query 802 and updated for each of one or more existing queries 802 for which engagement data changes. For item inference 1308 at the update, the item feature vector 848 is generated for each new item 804 and updated for each of one or more existing items 804 for which engagement data changes. A subset (e.g., less than all) of embeddings (e.g., feature vectors) of queries 802 and items 804 is updated in a database 1310. In some embodiments, each embedding is quantized before stored in the database 1310. Each update may be focused on a variation of the engagement data from a last update that immediately precedes the respective update.

In some embodiments, the inferences 1306 and 1308 rely on formulas 950 (FIG. 9B) and program codes 1080 (FIG. 10C) to compute embeddings (feature vectors) of query and item nodes. Nodes share neighbors in their L-hop neighborhoods. In some embodiments, an engagement graph 840, 880 is consolidated to simplify determination of the embeddings of the query and item nodes. For example, the item ranking computing device 102 generates the embeddings for nodes after one layer of propagation (e.g., on Layer-1) by (1) projecting all nodes into a low dimensional latent space (e.g., from Layer-1 to Layer-0 embeddings) and (2) propagating low dimensional latent space of neighbors into embeddings of each node (e.g., embeddings on Layer-1). For Layer-2, embeddings of nodes are determined iteratively by the above two operations. Using the above two-operation loop, the computing device 200 generates embeddings for nodes on any layer higher than Layer-2. In some embodiments, the inferences 1306 and 1308 run daily jobs. For example, the item ranking computing device 102 identifies the new queries 802 and items 804 that recently received user engagement and updates their embeddings each day, thereby helping reduce an inference time significantly. In some embodiments, the item ranking computing device 102 runs an inference pipeline for items 804 without engagement every day by introducing a pseudo query for each of these items 804. The item ranking computing device 102 generates embeddings for items 804 that have been recently registered in the user application 218.

In some embodiments, a normalized discounted cumulative gain (NDCG) is a measure of an effectiveness of a ranking system, taking into account a position of relevant items 804R in a ranked list. Items 804B that are higher in the ordered item list are given more weight than items 804B that are lower in the list. For example, the NDCG associated with the top 5 items has a delta value of 0.46% a P value of 0.26, and the NDCG associated with the top 10 items has a delta value of 0.82% a P value of 0.003. The graph-based relevance model 224 at least improves ranking performance for the top 10 items. In some embodiments, interleaving is applied to measure the impact of the graph-based relevance model 224 on engagement metrics, and the graph-based relevance model 224 does not have a negative impact on the engagement metrics.

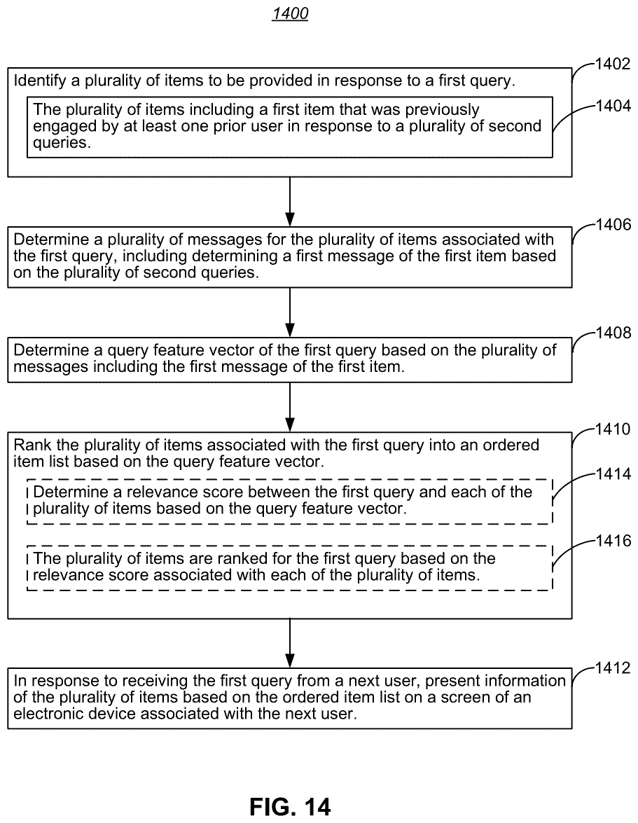

FIG. 14 is a flowchart illustrating a method 1400 for ranking items to be presented in response to a query, in accordance with some embodiments. Method 1400 is, optionally, governed by instructions that are stored in a non-transitory computer readable storage medium and that are executed by one or more processors of a system (e.g., including a item ranking computing device 102). Each of the operations shown in FIG. 14 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1400 may be combined and/or the order of some operations may be changed.

Method 1400 is performed by a system (e.g., item ranking computing device 102). In some embodiments, the system identifies (operation 1402) a plurality of items 804R to be provided in response to a first query 802A. The plurality of items 804R includes (operation 1404) a first item 804A that was previously engaged by at least one prior user in response to a plurality of second queries 802BR. The system may determine (operation 1406) a plurality of messages 812 for the plurality of items 804R associated with the first query 802A and a first message 812-1 of the first item 804A may be determined based on the plurality of second queries 802BR. In some embodiments, the system determines (operation 1408) a query feature vector 902 (FIG. 9) of the first query 802A based on the plurality of messages 812 including the first message 812-1 of the first item 804A, and ranks (operation 1410) the plurality of items 804R associated with the first query 802A into an ordered item list based on the query feature vector 902. In response to receiving the first query 802A from a next user, the system presents (operation 1412) information of the plurality of items 804R based on the ordered item list on a screen of an electronic device associated with the next user.

In some embodiments, the first item 804A has a respective query feature vector 854 for each of the plurality of second queries 802BR, and the first message 812-1 of the first item 804A is determined by combining the respective query feature vectors 854 of the plurality of second queries 802BR associated with the first item 804A using semantic weights.

In some embodiments, the system ranks the plurality of items 804R associated with the first query 802A by at least determining (operation 1414) a relevance level 810 between the first query 802A and each of the plurality of items 804R based on the query feature vector 902 of the first query 802A. The plurality of items 804R are ranked (operation 1416) for the first query 802A based on the relevance level 810 associated with each of the plurality of items 804R. Further, in some embodiments, the system determines an item feature vector 848 for each of the plurality of items 804R, and the relevance level 810 between the first query 802A and each of the plurality of items 804R is determined based on the query feature vector 902 of the first query 802A and the item feature vector 848 of the respective item 804R. In some embodiments, for each of the plurality of items 804R, the relevance level 810 is determined based on a dot product of the query feature vector 902 of the first query 802A and the item feature vector 848 of the respective item.

Additionally, in some embodiments, the system determines the item feature vector 848 of the first item 804A by identifying the plurality of second queries 802BR to which the first item 804A is provided in response. For each of the plurality of second queries 802BR associated with the first item 804A, a respective message of the respective second query 804BR is determined by combining a plurality of item features of a plurality of second items provided in response to the respective second query 804BR. The item feature vector 848 of the first item 804A is determined based on the respective messages of the plurality of second queries 802BR. The first item 804A is ranked in the plurality of items 804R associated with the first query 802A based on the query feature vector 902 of the first query 802A and the item feature vector 848 of the first item 804A.

In some embodiments, the first query 802A is associated with a collection of items 804 that has been engaged with users when provided to the users in response to the first query 802A. The system selects the plurality of items 804R from the collection of items 804 based on an edge weight (also called engagement weights) of each of the plurality of items 804R. Further, in some embodiments, the plurality of items 804R includes a predefined number of items in the collection of items 804. In some embodiments, each of the plurality of items 804R is selected in accordance with a determination of at least one of the following conditions: (1) that a number of times when the respective item 804R is selected as a query result is greater than a first time; and (2) a number of times when the respective item 804R is selected for review is greater than a second number. Further in some embodiments, the system determines the edge weight of each of the plurality of items 804R based on one or more of a number of times when the respective item 804R is selected as a query result, a number of times when the respective item 804R is selected for review, a number of times when the respective item 804R is selected as a candidate result, and a number of times when the respective item 804R is associated with a cursor hovering action during a duration of time.

In some embodiments, the plurality of items 804R includes an isolated item that was not previously provided in response to any query 802. The system may apply an encoder network to generate an item feature vector 848 of the isolated item and determines a new message of the isolated item based on the item feature vector 848 of the isolated item, the plurality of messages 812 including the new message.

In some embodiments, the system applies a graph-based relevance model 224 to determine a relevance level 810 of the first query 802A with each of the plurality of items 804R. Further, in some embodiments, the system trains the graph-based relevance model 224 using a collection of training queries 802T, a collection of training items 804T, and a triplet loss (FIG. 12). Each training query 802T corresponds to a set of relevant training items 804TR and a set of irrelevant items 804TI.

In some embodiments, the system obtains an engagement graph 840, 880 connecting a collection of items 804 and a collection queries 802 to each other, and the engagement graph 840, 880 is updated periodically, according to a predefined scheduled, or in response to a user request. Further, in some embodiments, the first query 802A may be newly received after a last update corresponding to the engagement graph 840, 880. In some embodiments, the engagement graph 840, 880 includes the first query 802A, the plurality of items 804R, and the plurality of second queries 802BR, and after a last update corresponding to the engagement graph 840, 880, one or more engagement relationships have been updated between the first query 802A and the plurality of items 804R and/or between the first item 804A and the plurality of second queries 802BR.

It should be understood that the particular order in which the operations in FIG. 14 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8A-13 are also applicable in an analogous manner to method 1400 described above with respect to FIG. 14. For brevity, these details are not repeated here.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
identify a plurality of items to be provided in response to a first query, the plurality of items including a first item that was previously engaged by at least one prior user in response to a plurality of second queries;
determine a plurality of messages for the plurality of items associated with the first query, including determining a first message of the first item based on the plurality of second queries;
determine a query feature vector of the first query based on the plurality of messages including the first message of the first item;
rank the plurality of items associated with the first query into an ordered item list based on the query feature vector of the first query; and
in response to receiving the first query from a next user, present information of the plurality of items based on the ordered item list on a screen of an electronic device associated with the next user.

2. The system of claim 1, wherein the first item has a respective query feature vector for each of the plurality of second queries, and the first message of the first item is determined by combining the respective query feature vectors of the plurality of second queries associated with the first item using semantic weights.

3. The system of claim 1, wherein ranking the plurality of items associated with the first query further comprises:
determining a relevance level between the first query and each of the plurality of items based on the query feature vector of the first query, wherein the plurality of items are ranked for the first query based on the relevance level associated with each of the plurality of items.

4. The system of claim 3, wherein ranking the plurality of items associated with the first query further comprises:
determining an item feature vector for each of the plurality of items, wherein the relevance level between the first query and each of the plurality of items is determined based on the query feature vector of the first query and the item feature vector of the respective item.

5. The system of claim 4, wherein for each of the plurality of items, the relevance level is determined based on a dot product of the query feature vector of the first query and the item feature vector of the respective item.

6. The system of claim 4, wherein determining the item feature vector for each of the plurality of items further includes determining the item feature vector of the first item, which further comprises:
identifying the plurality of second queries to which the first item is provided in response;
for each of the plurality of second queries associated with the first item, determining a respective message of the respective second query by combining a plurality of item features of a plurality of second items provided in response to the respective second query; and
determining the item feature vector of the first item based on the respective messages of the plurality of second queries;
wherein the first item is ranked in the plurality of items associated with the first query based on the query feature vector of the first query and the item feature vector of the first item.

7. The system of claim 1, wherein the first query is associated with a collection of items that has been engaged with users when provided to the users in response to the first query, and the memory further stores instructions for:
selecting the plurality of items from the collection of items based on an edge weight of each of the plurality of items.

8. The system of claim 7, wherein the plurality of items includes a predefined number of items in the collection of items.

9. The system of claim 6, wherein each of the plurality of items is selected in accordance with a determination of at least one of the following conditions:
(1) that a number of times when the respective item is selected as a query result is greater than a first time; and
(2) a number of times when the respective item is selected for review is greater than a second number.

10. The system of claim 7, wherein the memory further stores instructions for:
determining the edge weight of each of the plurality of items based on one or more of a number of times when the respective item is selected as a query result, a number of times when the respective item is selected for review, a number of times when the respective item is selected as a candidate result, and a number of times when the respective item is associated with a cursor hovering action during a duration of time.

11. A non-transitory computer-readable ppstorage medium, having instructions stored thereon, which when executed by one or more processors cause the processors to:
identify a plurality of items to be provided in response to a first query, the plurality of items including a first item that was previously engaged by at least one prior user in response to a plurality of second queries;
determine a plurality of messages for the plurality of items associated with the first query, including determining a first message of the first item based on the plurality of second queries;
determine a query feature vector of the first query based on the plurality of messages including the first message of the first item;
rank the plurality of items associated with the first query into an ordered item list based on the query feature vector of the first query; and
in response to receiving the first query from a next user, present information of the plurality of items based on the ordered item list on a screen of an electronic device associated with the next user.

12. The non-transitory computer-readable storage medium of claim 11, wherein the plurality of items includes an isolated item that was not previously provided in response to any query, and the non-transitory computer-readable storage medium further stores instructions for:
applying an encoder network to generate an item feature vector of the isolated item; and
determining a new message of the isolated item based on the item feature vector of the isolated item, the plurality of messages including the new message.

13. The non-transitory computer-readable storage medium of claim 11, further storing instructions for:
applying a graph-based relevance model to determine a relevance level of the first query with each of the plurality of items.

14. The non-transitory computer-readable storage medium of claim 13, further storing instructions for:
training the graph-based relevance model using a collection of training queries, a collection of training items, and a triplet loss, each training query corresponding to a set of relevant items and a set of irrelevant items.

15. A method, comprising:
at a system including a non-transitory memory having instructions stored thereon and at least one processor operatively coupled to the non-transitory memory and configured to read the instructions:
identifying a plurality of items to be provided in response to a first query, the plurality of items including a first item that was previously engaged by at least one prior user in response to a plurality of second queries;
determining a plurality of messages for the plurality of items associated with the first query, including determining a first message of the first item based on the plurality of second queries;
determining a query feature vector of the first query based on the plurality of messages including the first message of the first item;
ranking the plurality of items associated with the first query into an ordered item list based on the query feature vector of the first query; and
in response to receiving the first query from a next user, presenting information of the plurality of items based on the ordered item list on a screen of an electronic device associated with the next user.

16. The method of claim 15, further comprising:
obtaining an engagement graph connecting a collection of items and a collection queries to each other, wherein the engagement graph is updated periodically, according to a predefined scheduled, or in response to a user request.

17. The method of claim 16, wherein the first query is newly received after a last update corresponding to the engagement graph.

18. The method of claim 16, wherein the engagement graph includes the first query, the plurality of items, and the plurality of second queries, and after a last update corresponding to the engagement graph, one or more engagement relationships have been updated between the first query and the plurality of items and/or between the first item and the plurality of second queries.

19. The method of claim 15, wherein the first item has a respective query feature vector for each of the plurality of second queries, and the first message of the first item is determined by combining the respective query feature vectors of the plurality of second queries associated with the first item using semantic weights.

20. The method of claim 15, wherein ranking the plurality of items associated with the first query further comprises:
determining a relevance level between the first query and each of the plurality of items based on the query feature vector of the first query, wherein the plurality of items are ranked for the first query based on the relevance level associated with each of the plurality of items.
